(19) United States
(12) Patent Application Publication
(10) Pub. No.: US 2011/0107922 A1
(43) Pub. Date: May 12, 2011

(54) FOOD PRODUCT HEAT TREATMENT METHOD AND FOOD PRODUCT HEAT TREATMENT APPARATUS

(75) Inventors: Akira YAMAZAKI, Nagaoki-shi (JP); Yoshimi OHTAKI, Nagaoka-shi (JP); Tadao KOSAKA, Nagaoka-shi (JP); Akihiko SASAGAWA, Nagaoka-shi (JP)

(73) Assignee: ECHIGOSEIKA CO., LTD, Nagaoka-shi (JP)

(21) Appl. No.: 13/006,794

(22) Filed: Jan. 14, 2011

Related U.S. Application Data
(62) Division of application No. 11/994,530, filed on Jan. 3, 2008.

(30) Foreign Application Priority Data
Jul. 4, 2005 (JP) 2005-194878

(51) Int. Cl. A47J 27/08

(52) U.S. Cl. 99/359

(57) ABSTRACT

[Object] An object of the present invention is to provide an extremely practical and innovative food product heat treatment method capable of performing the same heat cooking and heat sterilization as that of the conventional technique while enhancing economy and productivity in comparison with the conventional technique.

[Means of Achievement] The food product heat treatment method is characterized in comprising placing a food product (2) in a hermetically sealed vessel (1) in which a prescribed vapor pressure is maintained or can be maintained; injecting a heating liquid heated by a heating source (8) to 100° C. or higher into a space in the hermetically sealed vessel (1) towards the food product; bringing the heating liquid injected in the hermetically sealed vessel (1) into contact with the food product (2), a food product package (3), or a cover body (4) of the food product (2) or food product package (3) rather than submerging the food product (2) in the heating liquid and performing heat treatment; and heat treating the food product (2) placed inside the hermetically sealed vessel (1), which is a hermetically sealed pressurized space, through heat of the heating liquid.

### TECHNICAL FIELD

The present invention relates to a food product heat treatment method and a food product heat treatment apparatus that are used for sterilization or cooking of a food product.

### BACKGROUND ART

Canned or retort-packaged food products are non-perishable foods that are heat-cooked and heat-sterilized by a process in which a food product sealed in a metal container or a flexible rosin bag (pouch) having heat resistance and airtightness is treated at high temperature and high pressure at a temperature of about 110° C. to 120° C. (in order to kill botulinus and other heat-resistant bacteria, an amount of heat corresponding to an F value of 4 (121° C.×4 minutes) is added), and are easily manufactured and sold, and widely used.

In the conventional technique, the food product is generally processed using steam or water (hot water) as the heating and pressurizing medium when the food product is subjected to high-temperature high-pressure treatment at 100° C. or higher. Specifically, in the case of water, a treatment tank is filled with water (hot water), and the food product is immersed, after which the water is heated while being pressurized by a pump or the like and maintained for a prescribed time as high-temperature high-pressure water. In the case of steam, a hermetically sealed vessel in which the food product is placed is filled with steam at high temperature and high pressure, and this state is maintained for a prescribed time. These processes are referred to hereinafter as the conventional technique.

### DISCLOSURE OF THE INVENTION

### Problems the Invention is Intended to Solve

However, in the case of water according to the conventional technique described above, since the entire treatment tank is filled with water at high temperature and high pressure, a long time is required to heat the water (hot water) to the prescribed temperature, and a large amount of heat energy is also required, which makes the technique uneconomical. The food product is also immersed in the high-temperature high-pressure water, and thus floats, and the food product recovery operation after treatment is therefore labor-intensive, and the transition to the next step cannot be performed rapidly, which reduces productivity. Furthermore, since the food product must be immersed in the water, the technique is difficult to adapt to food products that are not in a hermetically sealed package.

In the case of steam, the food product can be treated without being packaged, but because steam has poor thermal efficiency compared to water, a long time is required for the heating to reach the inside of the food product, and productivity is poor.

The present invention was developed to overcome the foregoing drawbacks in view of the current state of conventional food product heat treatment methods, and an object of the present invention is to provide an innovative food product heat treatment method that is capable of performing the same heat cooking and heat sterilization as the conventional technique while enhancing economy and productivity in comparison with the conventional technique, and to provide a food product heat treatment apparatus capable of implementing the food product heat treatment method.

### Means for Solving These Problems

The main points of the present invention are described below with reference to the attached drawings.

A first aspect of the present invention relates to a food product heat treatment method characterized in comprising placing a food product 2 in a hermetically sealed vessel 1 in which a prescribed vapor pressure is maintained or can be maintained; injecting a heating liquid heated by a heating source 8 to 100° C. or higher into a space in the hermetically sealed vessel 1 towards the food product; bringing the heating liquid injected in the hermetically sealed vessel 1 into contact with the food product 2, a food product package 3, or a cover body 4 of the food product 2 or food product package 3 rather than submerging the food product 2 in the heating liquid and performing heat treatment; and heat treating the food product 2 placed inside the hermetically sealed vessel 1, which is a hermetically sealed pressurized space, through heat of the heating liquid.

A second aspect of the present invention relates to the food product heat treatment method according to the first aspect, characterized in that an injection device part 12 for injecting the heating liquid is provided to the hermetically sealed vessel 1, the injection device part 12 is provided so as to be hermetically sealed and communicated with an inside of the hermetically sealed vessel 1, equal vapor pressures can be maintained in the injection device part 12 and the hermetically sealed vessel 1, and a heating liquid heated by a heating source is injected into the hermetically sealed vessel 1 from the injection device part 12.

A third aspect of the present invention relates to the food product heat treatment method according to any of the first and second aspects, characterized in that the inside of the hermetically sealed vessel 1 is maintained by pressurizing means at a vapor pressure that is equal to or higher than a saturation vapor pressure of the heating liquid injected into the hermetically sealed vessel 1, and the heating liquid at a temperature from 100° C. to 180° C. is injected into the hermetically sealed vessel 1.

A fourth aspect of the present invention relates to the food product heat treatment method according to the second aspect, characterized in that the heating liquid injected into the hermetically sealed vessel 1 by the injection device part 12 is recirculated and fed to the injection device part 12 and recirculated and injected into the hermetically sealed vessel 1 from the injection device part 12.

A fifth aspect of the present invention relates to the food product heat treatment method according to the third aspect, characterized in that the heating liquid injected into the hermetically sealed vessel 1 by the injection device part 12 is recirculated and fed to the injection device part 12 and recirculated and injected into the hermetically sealed vessel 1 from the injection device part 12.

A sixth aspect of the present invention relates to a food product heat treatment method characterized in comprising placing a hermetically sealed and packaged food product 2 in a hermetically sealed vessel 1 in which a prescribed vapor pressure is maintained or can be maintained; injecting a heating liquid at 80° C. or higher into a space in the hermetically sealed vessel 1 towards the hermetically sealed and packaged food product 2; bringing the heating liquid injected in the hermetically sealed vessel 1 into contact with a food product package 3 of the hermetically sealed and packaged food product 2, or a cover body 4 of the hermetically sealed and packaged food product 2 rather than submerging the hermetically sealed and packaged food product 2 in the heating liquid and performing heat treatment; and heat treating the hermetically sealed and packaged food product 2 placed inside the hermetically sealed vessel 1, which is a hermetically sealed pressurized space, through heat of the heating liquid.

A seventh aspect of the present invention relates to the food product heat treatment method according to the sixth aspect, characterized in that an injection device part 12 for injecting the heating liquid is provided to the hermetically sealed vessel 1, the injection device part 12 is provided so as to be hermetically sealed and communicated with an inside of the hermetically sealed vessel 1, equal vapor pressures can be maintained in the injection device part 12 and the hermetically sealed vessel 1, and a heating liquid heated by a heating source is injected into the hermetically sealed vessel 1 from the injection device part 12.

An eighth aspect of the present invention relates to the food product heat treatment method according to the sixth aspect, characterized in that the inside of the hermetically sealed vessel 1 is maintained by pressurizing means 10 at a vapor pressure that is equal to or higher than a saturation vapor pressure of the heating liquid injected into the hermetically sealed vessel 1, and the heating liquid at a temperature from 80° C. to 180° C. is injected into the hermetically sealed vessel 1.

A ninth aspect of the present invention relates to the food product heat treatment method according to the seventh aspect, characterized in that the inside of the hermetically sealed vessel 1 is maintained by pressurizing means 10 at a vapor pressure that is equal to or higher than a saturation vapor pressure of the heating liquid injected into the hermetically sealed vessel 1, and the heating liquid at a temperature from 80° C. to 180° C. is injected into the hermetically sealed vessel 1.

A tenth aspect of the present invention relates to the food product heat treatment method according to the seventh aspect, characterized in that the heating liquid injected into the hermetically sealed vessel 1 by the injection device part 12 is recirculated and fed to the injection device part 12 and recirculated and injected into the hermetically sealed vessel 1 from the injection device part 12.

An eleventh aspect of the present invention relates to the food product heat treatment method according to the eighth aspect, characterized in that the heating liquid injected into the hermetically sealed vessel 1 by the injection device part 12 is recirculated and fed to the injection device part 12 and recirculated and injected into the hermetically sealed vessel 1 from the injection device part 12.

A twelfth aspect of the present invention relates to the food product heat treatment method according to the ninth aspect, characterized in that the heating liquid injected into the hermetically sealed vessel 1 by the injection device part 12 is recirculated and fed to the injection device part 12 and recirculated and injected into the hermetically sealed vessel 1 from the injection device part 12.

A thirteenth aspect of the present invention relates to the food product heat treatment method according to any of the sixth through twelfth aspects, characterized in that the inside of the hermetically sealed vessel 1 is maintained by pressurizing means 10 at a vapor pressure that is 1.2 to 2.5 times the saturation vapor pressure of the heating liquid.

A fourteenth aspect of the present invention relates to a food product heat treatment apparatus characterized in that an injection device part 12 capable of injecting a heating liquid heated by a heating source 8 into a hermetically sealed vessel 1 is provided to a hermetically sealed vessel 1 in which a prescribed vapor pressure is maintained or can be maintained, and in which a food product 2 or a hermetically sealed and packaged food product 2 can be placed, the injection device part 12 is provided so as to be hermetically sealed and communicated with an inside of the hermetically sealed vessel 1, and equal vapor pressures can be maintained in the injection device part 12 and the hermetically sealed vessel 1.

A fifteenth aspect of the present invention relates to the food product heat treatment apparatus according to the fourteenth aspect, characterized in that an injection channel part 8a for injecting the heating liquid into the hermetically sealed vessel 1, and a recovery channel part 8b for recovering the heating liquid injected into the hermetically sealed vessel 1 and feeding the heating liquid to the injection channel part 8a are provided to the hermetically sealed vessel 1; and a recirculation injection device part 12 for re-injecting the heating liquid recovered from the hermetically sealed vessel 1 via the recovery channel part 8b into the hermetically sealed vessel 1 via the injection channel part 8a is formed by the hermetically sealed vessel 1, the injection channel part 8a, and the recovery channel part 8b.

A sixteenth aspect of the present invention relates to the food product heat treatment apparatus according to the fifteenth aspect, characterized in that the heating source 8 is provided to the recirculation injection device part 12.

A seventeenth aspect of the present invention relates to the food product heat treatment apparatus according to the fourteenth aspect, characterized in that a pressurizing device part 10 is provided to the hermetically sealed vessel 1 and configured so that the inside of the hermetically sealed vessel 1 is forcibly pressurized by the pressurizing device part 10, and a prescribed vapor pressure can be maintained.

An eighteenth aspect of the present invention relates to the food product heat treatment apparatus according to the fifteenth aspect, characterized in that a pressurizing device part 10 is provided to the hermetically sealed vessel 1 and configured so that the inside of the hermetically sealed vessel 1 is forcibly pressurized by the pressurizing device part 10, and a prescribed vapor pressure can be maintained.

A nineteenth aspect of the present invention relates to the food product heat treatment apparatus according to the sixteenth aspect, characterized in that a pressurizing device part 10 is provided to the hermetically sealed vessel 1 and configured so that the inside of the hermetically sealed vessel 1 is forcibly pressurized by the pressurizing device part 10, and a prescribed vapor pressure can be maintained.

A twentieth aspect of the present invention relates to the food product heat treatment apparatus according to any of the fourteenth through nineteenth aspects, characterized in that a liquid dispersing part 5 is provided to the injection device part 12 and configured so that the heating liquid can be injected in dispersed fashion into the hermetically sealed vessel 1 from the liquid dispersing part 5.

### Effects of the Invention

In the present invention as described above, a food product is placed in a hermetically sealed vessel in which a prescribed vapor pressure is maintained or can be maintained, and a heating liquid that is heated to 100° C. or higher by a heating source is injected into a space in the hermetically sealed vessel towards the food product, and the inside of the hermetically sealed vessel is therefore made into a hermetically sealed and pressurized space through at least the heating liquid injection, the heating liquid at 100° C. or higher can be reliably injected into the hermetically sealed vessel, and the same heat treatment as the conventional technique can be efficiently applied to the food product through the heat of the heating liquid at 100° C. or higher. Rather than filling the hermetically sealed vessel with liquid, immersing the food product in the heating liquid, and performing heat treatment, for example, the heating liquid injected into the hermetically sealed vessel is brought into contact with the food product, the food product package, or a cover body of the food product or the food product package, and the food product placed in the hermetically sealed vessel, which constitutes a hermetically sealed pressurized space, is heat treated by the heat of the heating liquid. Therefore, since only the amount of heat needed to heat the liquid injected into the hermetically sealed vessel is required in the heating source, the time required to heat the liquid is significantly reduced, and the heat energy required for heating is also significantly reduced relative to the conventional technique in which the entire treatment tank is filled with high-temperature high-pressure hot water, and the food product is immersed in the hot water. Since the food product is not immersed in the water, the method can also be applied to non-packaged food products, the food product can be recovered by a simple operation after heat treatment, and other effects are obtained, whereby highly versatile and highly productive heat treatment can be performed at a lower cost and using less energy than the conventional technique. Furthermore, since a heating liquid at a temperature adapted to the purpose can be injected merely by varying the vapor pressure inside the hermetically sealed vessel (hermetically sealed and pressurized space), an extremely practical and innovative food product heat treatment method is provided in which the temperature can be easily managed in a structure that uses a heating liquid at a temperature of 100° C. or higher.

The second and seventh aspects of the present invention provide an even more practical and innovative food product heat treatment method in which an injection device part for injecting the heating liquid is provided so as to be hermetically sealed and communicated with the inside of the hermetically sealed vessel. The heating liquid that is heated by the heating source to 100° C. or higher can therefore be reliably injected into the hermetically sealed vessel from the injection device part in which the same vapor pressure as that of the hermetically sealed vessel is maintained, and the food product can be heat treated while a hermetically sealed and pressurized space is reliably created in the hermetically sealed vessel.

The invention according to the third aspect provides an even more practical and innovative food product heat treatment method in which the inside of the hermetically sealed vessel can be reliably maintained by the pressurizing means at a vapor pressure that is the same as or higher than the saturation vapor pressure of the heating liquid injected into the hermetically sealed vessel, and the heating liquid at 100° C. or higher can therefore be prevented from vaporizing or boiling and reliably injected into the hermetically sealed vessel in the liquid state. The inside of the hermetically sealed vessel is maintained at high pressure in advance by the pressurizing means, whereby the heating liquid at 100° C. or higher can be immediately injected in the liquid state, and heat treatment can be performed at high thermal efficiency. Production efficiency is therefore even further enhanced, and because the temperature of the heating liquid injected by the pressurizing means can easily be set (managed), food product sterilization, food product cooking, and the like can easily be performed through temperature management that is adapted to the purpose. Depending on the food product, acrylamides or melanoidins can form in heating at temperatures above 180° C., but the temperature of the headed liquid can be reliably set to 180° C. or lower, a safe food product can easily be manufactured, and other effects are obtained.

The invention according to the fourth, fifth, and tenth through twelfth aspects provides an extremely practical and innovative food product heat treatment method in which the heating liquid injected into the hermetically sealed vessel by the injection device part is recirculated and fed to the injection device part, and recirculated and injected into the hermetically sealed vessel from the injection device part. Therefore, only a small amount of the heating liquid is consumed, and the heating liquid recovered after injection can be reused merely by re-heating the portion in which the temperature is reduced due to heat exchange with the food product. Therefore, no energy is wasted in the heating of the heating liquid, the economy of the process can be even further enhanced, an excess of the heating liquid does not accumulate in the hermetically sealed vessel, the inside of the hermetically sealed vessel is a hermetically sealed and pressurized space even when the heating liquid continues to be injected, and a configuration can be obtained in which the food product is not immersed.

The invention according to the sixth aspect provides an extremely practical and innovative food product heat treatment method in which the same operations/effects as the invention according to the first aspect are demonstrated with respect to a hermetically sealed and packaged food product. For example, even when the hermetically sealed and packaged food product includes air or other vapor together with liquid, and the internal pressure of the food product package is increased by heating of the heating liquid, since the pressure inside the hermetically sealed vessel is simultaneously increased by the heat of the heating liquid, and expansion of the food product package is suppressed, heat treatment can be performed while preventing the hermetically sealed and packaged food product from rupturing.

According to the eighth and ninth aspects of the present invention, even in a case in which a hermetically sealed and packaged food product, for example, includes air or other vapor together with liquid, and a food product package is used that ruptures even when heated to about 80° C. at normal pressure (gauge pressure of zero), the inside of the hermetically sealed vessel is reliably maintained by the pressurizing means at a vapor pressure that is higher than the saturation vapor pressure of the heating liquid, and rupturing of the packaged food product can easily be prevented during heat treatment. When heat treatment is performed using a heating liquid at 100° C. or higher, since the vapor pressure inside the hermetically sealed vessel can easily be maintained by the pressurizing means at a vapor pressure that is higher than the saturation vapor pressure of the heating liquid, boiling of the liquid in the food product is suppressed by the high vapor pressure maintained within the hermetically sealed vessel, the internal pressure in the food product package does not easily increase, and expansion of the food product package is suppressed by the vapor pressure inside the hermetically sealed vessel even when the internal pressure increases. Heat treatment can therefore be performed while rupturing is reliably prevented.

The inside of the hermetically sealed vessel is also maintained at high pressure in advance by the pressurizing means, whereby an even more practical and innovative food product heat treatment method is provided in which the heating liquid at 100° C. or higher can be immediately injected in the liquid state, heat treatment can be performed at high thermal efficiency, and the temperature of the heating liquid injected by the pressurizing means can easily be set (managed). Therefore, food product sterilization, food product cooking, and the like can easily be performed through temperature management that is adapted to the purpose, the temperature of the headed liquid can be reliably set to 180° C. or lower, a safe food product can easily be manufactured, and other effects are obtained.

The invention according to the thirteenth aspect provides an even more practical and innovative food product heat treatment method in which the heating liquid can be reliably injected into the hermetically sealed vessel in the liquid state while vaporization or boiling of the heating liquid is suppressed, and a hermetically sealed and packaged food product can be efficiently heat treated. Even when a hermetically sealed and packaged food product, for example, includes air or other vapor together with liquid, the internal pressure of the hermetically sealed and packaged food product is prevented from increasing by the vapor pressure inside the hermetically sealed vessel, rupturing can be prevented, and the packaged food product can also be prevented from being compressed and ruptured by external pressure in the hermetically sealed vessel. This method is also effective in a food product package in which the strength of the container itself and the seal strength are low, such as in a top-covered resin container, for example.

The invention according to the fourteenth aspect provides an extremely practical and innovative food product heat treatment apparatus in which a heating liquid that is heated by a heating source to 100° C. or higher can be injected from an injection device part that is provided so as to be hermetically sealed and communicated with the inside of the hermetically sealed vessel, and the food product heat treatment method that demonstrates the aforementioned operations/effects can be reliably implemented.

The invention according to the fifteenth aspect provides an extremely practical and innovative food product heat treatment apparatus in which a recirculation injection device part is formed for re-injecting the heating liquid recovered via a recovery channel part from inside the hermetically sealed vessel into the hermetically sealed vessel via an injection channel part. Therefore, only a small amount of the heating liquid is consumed, and the heating liquid recovered after injection can be reused merely by re-heating the portion in which the temperature is reduced due to heat exchange with the food product. Therefore, no energy is wasted in the heating of the heating liquid, the economy of the process can be even further enhanced, an excess of the heating liquid does not accumulate in the hermetically sealed vessel, the inside of the hermetically sealed vessel is a hermetically sealed and pressurized space even when the heating liquid continues to be injected, and a configuration in which the food product is not immersed can easily be designed and implemented.

The invention according to the sixteenth aspect provides an extremely practical and innovative food product heat treatment apparatus in which a heating source is provided to the recirculation injection device part. The recirculated heating liquid can therefore be efficiently heated, even less energy is wasted in heating the heating liquid, and the economy of the process can be even further enhanced.

The invention according to the seventeenth through nineteenth aspects provides an even more practical and innovative food product heat treatment apparatus in which the inside of the hermetically sealed vessel can be forcibly pressurized and maintained at a prescribed vapor pressure by a pressurizing device part. The heating liquid at 100° C. or higher can therefore be efficiently injected, and the temperature of the injected heating liquid can be easily managed.

The invention according to the twentieth aspect provides an extremely practical and innovative food product heat treatment apparatus in which the heating liquid can easily be injected in distributed fashion into the hermetically sealed vessel uniformly and without unevenness. Heat cooking and heat sterilization can therefore be performed even more effectively.

### BRIEF DESCRIPTION OF THE DRAWINGS

FIG. 1 is a schematic diagram showing the food product processing apparatus of Example 1;

FIG. 2 is a diagram showing the air-included packaged food product of Example 1;

FIG. 3 is a diagram showing the case of Example 1;

FIG. 4 is a graph showing the measured values in Experimental Example 2;

FIG. 5 is a graph showing the measured values in Experimental Example 3; and

FIG. 6 is a graph showing the measured values in Experimental Example 4.

### KEY

1 hermetically sealed vessel
2 food product
3 food product package
4 cover body
5 liquid dispersing part
8 heating source
8a injection channel part
8b recovery channel part
10 pressurizing means, pressurizing device part
12 injection device part, recirculation injection device part

### BEST MODE FOR CARRYING OUT THE INVENTION

Preferred embodiments (the manner in which the present invention is implemented) of the present invention are briefly described below with reference to the diagrams while indicating the effects of the present invention.

A food product 2 is placed in a hermetically sealed vessel 1, and a heating liquid that is heated to 100° C. or higher by a heating source 8 is injected into a space in the hermetically sealed vessel 1 towards the food product 2, but in the present invention, the heating liquid is brought into contact with the food product 2, a food product package 3, or a cover body 4 of the food product 2 or food product package 3 instead of filling the inside of the hermetically sealed vessel 1 with the injected heating liquid and immersing the food product 2 to heat-treat the food product 2. The hermetically sealed vessel 1 thus becomes a hermetically sealed and pressurized space, and the food product 2 is also heat treated at 100° C. or higher by the heat of the heating liquid at 100° C. or higher.

Specifically, when water is employed as the heating liquid, for example, the heating liquid does not exceed 100° C. under normal pressure, but when the heating liquid at 100° C. or higher is injected into the hermetically sealed vessel 1, the vapor inside the hermetically sealed vessel 1 is heated by the heat of the heating liquid, and expands. A hermetically sealed and pressurized space in which the vapor pressure is increased is thereby created inside the hermetically sealed vessel 1, and the heating liquid at a temperature in excess of 100° C. can be injected in the liquid state without vaporizing or boiling. An injection device part 12 for injecting the heating liquid is also provided to the hermetically sealed vessel 1 so as to be hermetically sealed and communicated with the inside of the hermetically sealed vessel 1, for example, whereby the heating liquid heated to 100° C. or higher by the heating source 8 can be reliably injected into the hermetically sealed vessel 1.

Since liquid has good thermal conduction efficiency in comparison to steam and other vapor, the food product 2 is efficiently heat treated in a short time by the heat of the heating liquid at 100° C. or higher. In particular, when the vapor pressure inside the hermetically sealed vessel 1 is maintained by a pressurizing means 10 at a higher vapor pressure than the saturation vapor pressure of the heating liquid at this time, the heating liquid at 100° C. or higher can be reliably and immediately injected in the liquid state, and the food product 2 is therefore heat treated in an even shorter time with good thermal efficiency.

An uncooked or semi-cooked food product 2 is heat treated by the heat of the heating liquid at 100° C. or higher.

According to the present invention, maintaining a high vapor pressure inside the hermetically sealed vessel 1 makes it possible to increase the temperature of the heating liquid to the same heating temperature as fry-cooking or deep-fry cooking that uses oil. For example, so-called non-fried cooking that does not use oil can be performed for the food product 2 by maintaining the vapor pressure inside the hermetically sealed vessel 1 at a high pressure that enables injection of the heating liquid at about 180° C. (maintaining a vapor pressure that is the same as or higher than the saturation vapor pressure of the heating liquid at 180° C.) and heat-treating the food product 2 in the heating liquid at about 180° C. Since acrylamides or melanoidins occur in some food products when the heat treatment temperature of the food product 2 is higher than 180° C., it is preferred that heat treatment be performed by injection of a heating liquid at 180° C. or lower (a temperature lower than 180° C. is preferred).

Coliform bacteria in the food product 2 can be killed at about 60° C., heat-resistant botulinus can be killed at about 110° C. to 120° C., and almost all microbes can be killed at about 110° C. to 120° C.

Specifically, a reliable heat sterilization treatment can be performed on the food product 2 by maintaining the vapor pressure inside the hermetically sealed vessel 1 at a high pressure that enables injection of the heating liquid at about 120° C. (maintaining a vapor pressure that is the same as or higher than the saturation vapor pressure of the heating liquid at 120° C.), and injecting the heating liquid at 120° C.

Since a heating liquid at a temperature adapted to the purpose can be injected by changing the vapor pressure inside the hermetically sealed vessel 1 in this manner, temperature management can be facilitated in a configuration in which a heating liquid at 100° C. or higher is used. This temperature management can be made even easier by using the pressurizing means 10, for example.

The inside of the hermetically sealed vessel 1 is also maintained at a vapor pressure that is the same as or higher than the saturation vapor pressure of the heating liquid at 100° C. or higher, whereby vaporization or boiling of the moisture in the food product 2 does not easily occur even when the food product 2 is heat treated at 100° C. or higher, and heat treatment can be performed without significantly compromising the texture or flavor of the food product 2.

Consequently, in the present invention, the same heat treatment as the conventional technique can be performed for the food product 2 as described above with greater efficiency than the conventional technique.

Since only the amount of heat needed to heat the liquid (heating liquid) injected into the hermetically sealed vessel 1 is required, the time required to heat the liquid is significantly reduced, and the heat energy required for heating is also significantly reduced relative to the conventional technique in which the entire treatment tank is filled with high-temperature high-pressure hot water, and the food product is immersed in the hot water. Since the food product 2 is not immersed in the water as in the conventional technique, the food product 2 can be recovered by a simple operation after heat treatment, efficient production is made possible, and enhanced productivity and reduced cost can be obtained at the same time.

A case will be described in which a hermetically sealed and packaged food product 2 is heat treated.

There may be two types of hermetically sealed and packaged food products 2 that include, for example, a food product that is hermetically sealed and packaged in a state in which air and other non-condensable gases are not included, i.e., a de-aerated packaged food product 2, and a food product that is hermetically sealed and packaged in a state in which air and other non-condensable gases are included, i.e., an aerated packaged food product 2. However, in any of these packaging forms, when the food product 2 includes liquid, boiling occurs when heating causes the vapor pressure of the liquid in the food product 2 to be equal to the external pressure, and vaporization occurs from within the liquid in the food product 2.

The vapor pressure at a prescribed temperature of a liquid is easily calculated by the Antoine equation (1). The vapor pressure can be calculated even in a multi-component system such as the food product 2.

P=A−B/(C+θ) (1)

In the equation (1), P is the vapor pressure, θ is the temperature, and A, B, and C are constants specific to the various components.

For example, when the vapor pressure is that of water at 110° C., the vapor pressure of water at 120° C. and a gauge pressure of 0.042 MPa is 0.097 MPa, and the vapor pressure follows Equation (1) in the range from 10° C. to 168° C.

When 1 mL of water undergoes a state change to steam due to heating, the water has a volume of 1700 mL (100° C.)

Therefore, in the case of a hermetically sealed and packaged food product 2, when the food product 2 is heated by the heating liquid, the food product package 3 may expand and rupture due to the vaporization of water included in the food product 2. However, since the air inside the hermetically sealed vessel 1 is also heated by the heat of the heating liquid, and a hermetically sealed and pressurized space is formed having substantially the same internal pressure as the food product package 3 in the present invention, the expansion of the food product package 3 is suppressed by the vapor pressure inside the hermetically sealed vessel 1, and heat treatment is performed while rupturing is prevented.

When an experiment was performed in which a food product 2 was packaged in a food product package 3 in which a resin container 7 was sealed by an upper lid 6, and the food product 2 was heat treated by injection of a heating liquid at 80° C. inside a hermetically sealed vessel 1 at one atmosphere (gauge pressure: 0) (Experimental Example 1 described hereinafter), rupturing of the food product package 3 under these conditions was confirmed. In other words, the strength of the food product package 3 itself, the volume of air inside the food product package 3, the seal strength of the food product package 3, and other factors are significantly related to the cause of failure of the food product package 3, but it was learned that such operations/effects as those described above are sometimes not obtained with respect to a low-strength food product package 3 in particular (the abovementioned effects/operations are considered to be attainable in the case of a high-strength food product package 3 such as a can). Furthermore, it was confirmed that rupturing occurs even when the same food product package 3 (resin container 7 having an upper lid 6) having a large volume of included air and low seal strength comes in contact with hot water at about 80° C.

Based on these experimental results, a minimum temperature of 80° C. or higher was set for the heating liquid during heat treatment of a food product 2 that is hermetically sealed and packaged in a food product package 3. It was also learned that particularly when a food product package 3 is used in which the seal strength and the strength of the container itself are low, the vapor pressure inside the hermetically sealed vessel 1 must be maintained at a higher vapor pressure than the saturation vapor pressure of the heating liquid even when heat treatment is performed using a heating liquid at a temperature that allows liquid injection at normal pressure.

When an aerated-packaged food product 2 is heated, the maintained pressure must be set higher than when a de-aerated packaged food product 2 is heated.

Reasons for this are suggested below.

When an aerated packaged food product 2 is heated, according to Boyle-Charles Law, a pressure Pg that accompanies vapor expansion occurs together with the vapor pressure of the liquid. The partial pressure Pw of the liquid component in the vapor that is compressed by the pressure of the non-condensable gas is larger than the saturation pressure P.

Specifically, in the case of an aerated packaged food product 2, it is known that the vapor pressure is higher than that indicated by Antoine's equation (1), an increase rate E is used to indicate the increase ratio, and the increase rate is calculated by Equation (2) below.

E=Pw/P=(1/φ)exp{V(Pg−P)/RT} (2)

In Equation (2), φ is a fugacity constant, V is the molar volume of the liquid, R is the gas constant, and T is the temperature.

In other words, according to Equation (2), the vapor pressure of a liquid that includes air or another non-condensable gas can be considered to be {(Pg+P×E)/P} times larger than the vapor pressure of a liquid that does not include air or another non-condensable gas. For example, according to Antoine's equation, the saturation vapor pressure (gauge pressure) of water is 0.097 MPa when water is heated to 120° C. The pressure due to expansion of air is calculated from Boyle-Charles Law, and is {(273+120)/(273+20)}×0.101=0.135 MPa (absolute pressure), or a gauge pressure of 0.034 MPa when the initial temperature is 20° C. Accordingly, when water that includes air is sealed and heated to 120° C., a gauge pressure of 0.097 (partial pressure of water vapor)+0.034 (partial pressure of air)=0.131 MPa (total pressure) can be calculated. However, the actual measured pressure was 0.180 MPa, and an internal pressure approximately 1.4 times the saturation vapor pressure occurred.

When an aerated packaged food product 2 is heated, the maintained pressure must be set higher than the pressure when air is not included, and maintaining the vapor pressure inside the hermetically sealed vessel 1 at a higher vapor pressure than the saturation vapor pressure of the heating liquid is also effective in this case for preventing the food product package 3 from rupturing.

Although there is a dependence on what type of food product package 3 is used in heat treatment, it was confirmed by experimentation that at least in the case of a package having relatively low seal strength and low strength of the container itself, such as a resin container 7 having an upper lid 6, when the vapor pressure inside the hermetically sealed vessel 1 is less than 1.2 times the saturation vapor pressure of the heating liquid during injection of the heating liquid into the hermetically sealed vessel 1 as described also in the example described hereinafter, the pressure of the food product package 3 due to vaporization of moisture and expansion of air is greater than the pressure inside the hermetically sealed vessel 1, and rupturing can occur according to the condition of the food product package 3 and the included amount of air. Since the pressure inside the hermetically sealed vessel 1 is also too large with respect to the pressure inside the food product package 3 when the pressure inside the hermetically sealed vessel 1 is greater than 2.5 times the saturation vapor pressure of the heating liquid, rupturing can occur according to the condition of the food product package 3.

According to these experimental results, a hermetically sealed and packaged food product 2 may be heat treated extremely well without rupturing even when a food product package 3 is used that has relatively low seal strength and low strength of the container itself, such as a resin container 7 having at least an upper lid 6, by maintaining the vapor pressure inside the hermetically sealed vessel 1 at 1.2 to 2.5 times the saturation vapor pressure of the heating liquid.

The food product heat treatment method of the present invention described above can easily be implemented through the use of a food product heat treatment apparatus having a configuration in which a injection device part 12 capable of injecting a heating liquid heated by a heating source 8 into a hermetically sealed vessel 1 is provided to a hermetically sealed vessel 1 in which a prescribed vapor pressure is maintained or can be maintained, and into which a food product 2 or a food product 2 hermetically sealed and packaged in a food product package 3 can be placed, the injection device part 12 is provided so as to be hermetically sealed and communicated with the inside of the hermetically sealed vessel 1, and the same vapor pressure can be maintained in the injection device part 12 and the hermetically sealed vessel 1.

### EXAMPLES

Examples of the present invention are described below with reference to the diagrams.

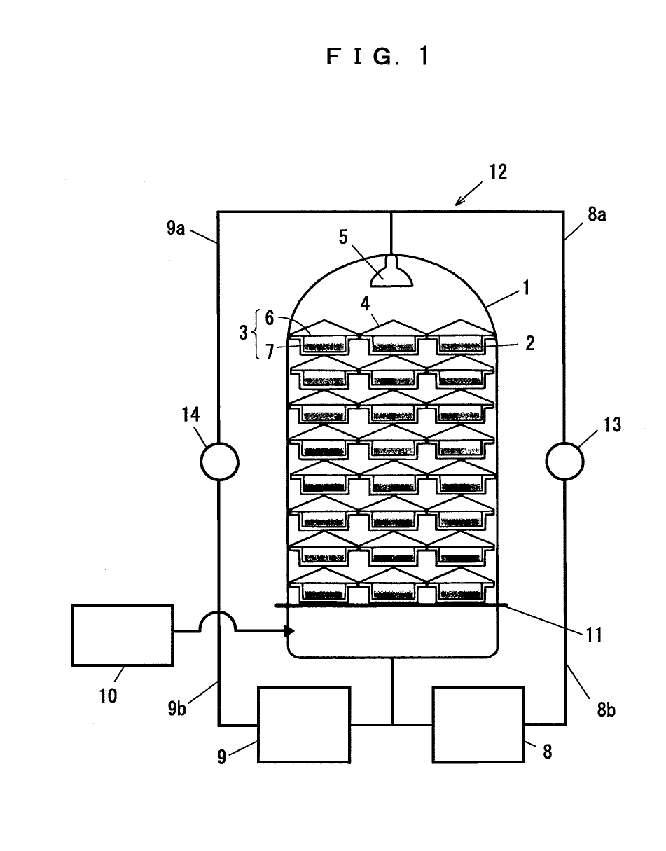

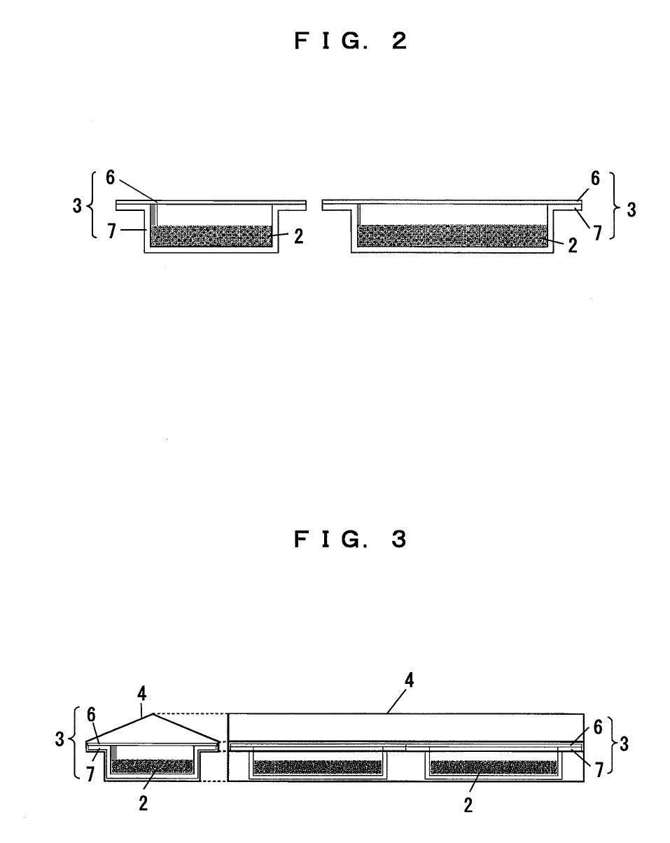

FIG. 1 shows the food product heat treatment apparatus of the present example. The present example is of a case in which a plurality of food products 2 (hereinafter referred to as an aerated packaged food product 2) hermetically sealed and packaged in a state in which air is included in a food product package 3 such as the resin container 7 having an upper lid 6 shown in FIG. 2 is accommodated in a case-shaped cover body 4 such as the one shown in FIG. 3, a plurality of the case-shaped cover bodies 4 is placed in a hermetically sealed vessel 1 of the food product heat treatment apparatus in which a prescribed vapor pressure is maintained or can be maintained, hot water at 80° C. to 120° C. is injected into the hermetically sealed vessel 1, and the heating liquid injected into the hermetically sealed vessel 1 is brought into contact with the cover bodies 4 in which the food products 2 are accommodated, and the food products 2 placed in the hermetically sealed vessel 1 as a hermetically sealed and pressurized space are heat treated by the heat of the heating liquid, rather than by immersing the cover bodies 4 in which the food products 2 are accommodated in the heating liquid.

The components of the food product heat treatment apparatus of the present example will be specifically described.

The hermetically sealed vessel 1 is configured so that the food product 2 or hermetically sealed and packaged food product 2 is placed therein, and the hermetically sealed vessel 1 has heat resistance and pressure resistance whereby a prescribed vapor pressure is maintained or can be maintained. The reference numeral 11 in the drawing indicates a deck. In the present example, the hermetically sealed vessel 1 and the deck 11 are made of stainless steel and configured so as to have excellent corrosion resistance.

In the present example, a pressurizing device part 10 is provided to the hermetically sealed vessel 1, and the inside of the hermetically sealed vessel 1 can be forcibly pressurized and maintained at the prescribed vapor pressure by the pressurizing device part 10.

A compressor 10 is specifically used as the pressurizing device part 10. Through the use of the compressor 10, air or other vapor can be directed into the hermetically sealed vessel 1, and the inside of the hermetically sealed vessel 1 can be reliably maintained at a vapor pressure higher than the saturation vapor pressure of the heating liquid.

The present example has a configuration in which the injection device part 12 for injecting the heating liquid into the hermetically sealed vessel 1 is provided, and the injection device part 12 is provided so as to be hermetically sealed and communicated with the hermetically sealed vessel 1. Furthermore, a heating source 8 is provided to the injection device part 12 in the present example.

In the present example, since the hermetically sealed vessel 1, the injection device part 12, and the heating source 8 are hermetically sealed and communicated with each other, and the same vapor pressure can be maintained in the heating source 8, the injection device part 12, and the hermetically sealed vessel 1, heating can be performed efficiently while the same pressure as the pressure inside the hermetically sealed vessel 1 is applied to the heating liquid of the heating source 8 even when a special pressurizing device is not provided to the heating source 8. The heating liquid heated by the heating source 8 to 100° C. or higher can also be reliably injected into the hermetically sealed vessel 1 from the injection device part 12, in which the same vapor pressure as the pressure inside the hermetically sealed vessel 1 is maintained, and the food product can be heat treated while a hermetically sealed and pressurized space is reliably maintained inside the hermetically sealed vessel.

In the present example, the injection device part 12 is composed of the hermetically sealed vessel 1, an injection channel part 8a, and a recovery channel part 8b, a recirculation injection device part 12 is formed in which the heating liquid is injected into the hermetically sealed vessel 1 from the injection channel part 8a, and the heating liquid injected into the hermetically sealed vessel 1 is recovered by the recovery channel part 8b and re-injected into the hermetically sealed vessel 1 via the injection channel part 8a, and the heating source 8 is provided to the recirculation injection device part 12.

Since the injection device part 12 is a recirculation injection device part 12 in the present example, only a small amount of the heating liquid is consumed, and the heating liquid recovered after injection can be reused merely by re-heating the portion in which the temperature is reduced due to heat exchange with the food product. Therefore, no energy is wasted in the heating of the heating liquid, the economy of the process can be even further enhanced, an excess of the heating liquid does not accumulate in the hermetically sealed vessel 1, and the food product inside the hermetically sealed vessel 1 is not immersed even when the heating liquid continues to be injected.

The present example also has a configuration in which the heating source 8 is provided on the side of the recovery channel part 8b of the recirculation injection device part 12. The heating liquid is thus prevented from decreasing in temperature, and heating by the heating source 8 can be performed at low cost relative to a case in which the heating source 8 is provided on the side of the injection channel part 8a of the recirculation injection device part 12.

In a configuration besides that of the present example, the heating source 8 may be provided inside the hermetically sealed vessel 1, for example, and when the heating source 8 is provided inside the hermetically sealed vessel 1, there is even less temperature reduction of the heating liquid, and heating by the heating source 8 can be performed at even lower cost.

In a configuration in which a gas heater, electric heater, heat exchanger, or other appropriate heating device is provided as the heating source 8, and a temperature control device is provided for controlling the heating temperature of the heating liquid, a configuration is adopted in which heating is performed by the heating device and the temperature control device when the temperature of the heating liquid of the heating source 8 is lower than the set temperature, and heating is not performed when the temperature of the heating liquid of the heating source 8 is equal to or higher than the set temperature.

A thermostat is specifically employed as the temperature control device. Through the use of the thermostat, the heating temperature of the heating liquid can be easily adjusted, the desired temperature of the heating liquid can be reliably obtained, and heating can be performed with low energy consumption while excessive temperature increases of the heating liquid are prevented.

A configuration is adopted in the present example in which a liquid dispersing part 5 is provided to the recirculation injection device part 12, and the heating liquid can be injected in dispersed fashion from the liquid dispersing part 5 into the space in the hermetically sealed vessel 1.

Specifically, a nozzle 5 for injecting the heating liquid in dispersed fashion in the form of a mist or a shower from the top of the hermetically sealed vessel 1 is employed as the liquid dispersing part 5. Through the use of the nozzle 5 for injecting the heating liquid in dispersed fashion in the form of a mist or a shower, the heating liquid is uniformly dispersed in the space inside the hermetically sealed vessel 1, the food product 2 can be uniformly heated, and production efficiency is enhanced.

Any liquid dispersing part 5 may be used insofar as the heating liquid can be dropped or injected towards the food product 2 in the space inside the hermetically sealed vessel 1, and the liquid dispersing part 5 may be provided not only at the top of the hermetically sealed vessel 1, but also at the bottom or sides thereof.

A configuration is adopted in the present example in which a cooling source 9 is provided so as to be hermetically sealed and communicated with the hermetically sealed vessel 1, the cooling liquid cooled by the cooling source 9 is injected into the hermetically sealed vessel 1 via an injection channel 9a, and a recovery channel 9b is also provided for recovering the cooling liquid inside the hermetically sealed vessel 1 that is injected from the injection channel 9a. The food product inside the hermetically sealed vessel 1 can thereby be efficiently cooled. In a configuration other than that of the present example, the cooling source 9 may be a ventilation cooling structure for directing air or other vapor into the hermetically sealed vessel 1. Alternatively, the cooling source 9 may be a structure for dispersing water directly into the hermetically sealed vessel 1 from plumbing or a water storage tank.

The heating source 8 and the cooling source 9 in the present example may also be disposed inside the hermetically sealed vessel 1.

The reference numeral 13 in the drawings indicates a pump for recirculating and injecting the heating liquid, and the reference numeral 14 indicates a pump for recirculating and injecting the cooling liquid.

In the present example, the food product 2 is stored inside a case-shaped cover body 4 instead of being directly placed inside the hermetically sealed vessel 1. Placement and arrangement of the food product 2 inside the hermetically sealed vessel 1 are thereby facilitated, this operation can be automated, and excellent workability and mass production properties are obtained. There is also no more wetting of the food product 2 accommodated in the case-shaped cover body 4, the method can be applied to a food product 2 in a tray or other open-top container, or a food product 2 that is susceptible to wetting with water, and the moisture removal step can also be safely omitted.

Besides the case shape adopted in the present example for the cover body 4, a roof-shaped cover body, a cylinder-shaped cover body, or other appropriate cover body may be employed that prevents the heating liquid from directly contacting the food product 2, but a case-shaped cover body 4 has excellent sealing properties and does not allow the heat of the heating liquid to easily escape, and the food product 2 can therefore be efficiently heated.

A configuration is adopted in the present example in which a plurality of case-shaped cover bodies 4 is placed on the deck 11, but an appropriate arrangement method other than that of the present example may also be employed, in which case-shaped cover bodies 4 are in a suspended arrangement inside the hermetically sealed vessel 1.

Specific experimental examples of the present example are described below.

### Experimental Example 1

Experimental Example 1 is a case in which a food product 2 (hereinafter referred to as an aerated packaged food product 2) hermetically sealed and packaged in a state in which air at 20° C. was included in a resin container 7 or other food product package having an upper lid 6 was heated to 80° C. at atmospheric pressure.

Water evaporates from the interface (surface) with air or the like even at 0° C., and water vaporizes from liquid to vapor even at or below the boiling point. When the food product 2 including moisture was heated to 80° C., water evaporated from the surface, the air expanded, and the food product package 3 ruptured even at an atmospheric pressure of 0.101 MPa.

The pressure generated by the expansion of air was {(273+80)/(273+20)}×0.101=0.122 MPa (absolute pressure).

Accordingly, when the aerated packaged food product 2 was heated to 80° C., it was confirmed that pressurization of 1.21 times (0.122/0.101) atmospheric pressure was necessary. The food product package 3 expanded during heating to 75° C., but rupturing did not occur.

### Experimental Example 2

Experimental Example 2 is a case in which a food product 2 (hereinafter referred to as an aerated packaged food product 2) hermetically sealed and packaged in a state in which air at 20° C. was included in a resin container 7 or other food product package 3 having an upper lid 6 was heated to 100° C. at a pressure 0.036 MPa higher than atmospheric pressure.

The aerated packaged food product 2 was inserted into a case-shaped cover body 4 and pressurized by the feeding of air into the hermetically sealed vessel 1 by the compressor 10, and a pressure of 0.036 MPa (gauge pressure) was maintained.

The water of the heating source 8 was then heated to 100° C., and the resultant hot water was dispersed from above the case 4. After about 35 minutes had elapsed, the dispersion of hot water was stopped, and water at 20° C. was dispersed from above the case 4 from the cooling source 9, and the case 4 was cooled.

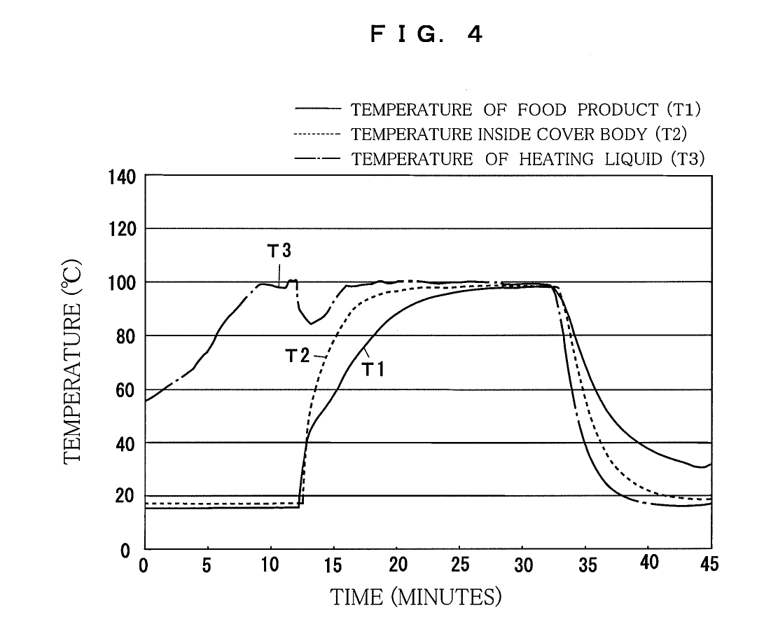

FIG. 4 shows the results in which the temperature of the food product 2 was measured as T1, the temperature inside the case-shaped cover body 4 as T2, and the temperature of the water (heating liquid) of the heating source 8 as T3.

When water is heated to 100° C., according to Antoine's equation, the saturation vapor pressure (absolute pressure) of the water is 0.101 MPa, and the gauge pressure is 0 MPa. The pressure generated by the expansion of air is {(273+100)/(273+20)}×0.101=0.129 MPa (absolute pressure), and the gauge pressure is 0.028 MPa.

In other words, when the food product 2 is heated to 100° C., a gauge pressure of 0 (partial pressure of water vapor)+0.028 (partial pressure of air)=0.028 MPa (total pressure) can be calculated. However, the actual measured pressure was 0.036 MPa (gauge pressure), and an internal pressure approximately 1.3 times the saturation vapor pressure occurred.

Consequently, it was confirmed that a pressure 1.3 times atmospheric pressure was necessary when the food product 2 was heated to 100° C. without rupturing the food product package 3.

When pressure was not applied using air (when the compressor 10 was not operated), the food product package 3 ruptured at 80° C. during heating.

### Experimental Example 3

Experimental Example 3 is a case in which a food product 2 (hereinafter referred to as an aerated packaged food product 2) hermetically sealed and packaged in a state in which air at 20° C. was included in a resin container 7 or other food product package 3 having an upper lid 6 was heated to 110° C. at a pressure 0.100 MPa higher than atmospheric pressure.

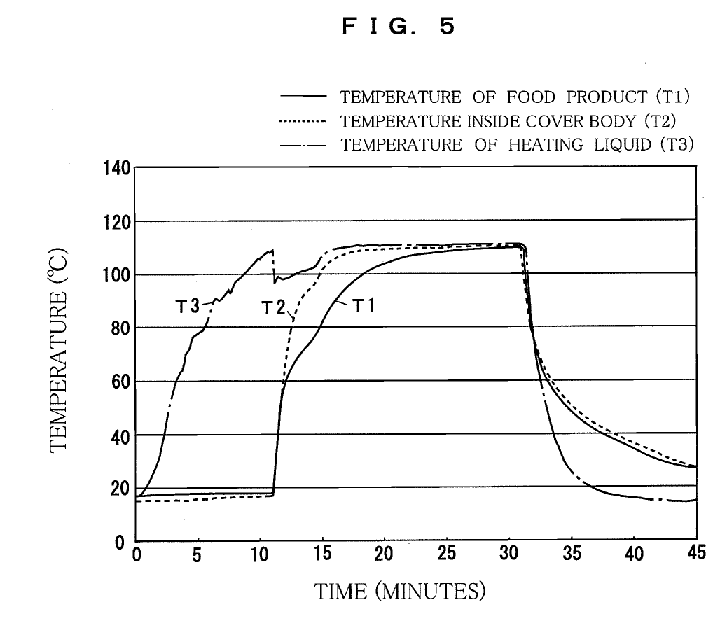

FIG. 5 shows the results in which the temperature of the food product 2 was measured as T1, the temperature inside the case-shaped cover body 4 as T2, and the temperature of the water (heating liquid) of the heating source 8 as T3, in the same manner in Experimental Example 3 as in Experimental Example 2.

When water is heated to 110° C., according to Antoine's equation, the saturation vapor pressure of the water is a gauge pressure of 0.042 MPa. The pressure generated by the expansion of air is {(273+110)/(273+20)}×0.101=0.132 MPa (absolute pressure), and the gauge pressure is 0.031 MPa.

In other words, when the food product 2 is heated to 110° C., a gauge pressure of 0.042 (partial pressure of water vapor)+0.031 (partial pressure of air)=0.073 MPa (total pressure) occurring inside can be calculated. However, the actual measured pressure was 0.100 MPa, and an internal pressure approximately 1.4 times the saturation vapor pressure occurred.

Consequently, it was confirmed that a pressure 1.4 times atmospheric pressure was necessary when the food product 2 was heated to 110° C. without rupturing the food product package 3.

When pressure was not applied using air (when the compressor 10 was not operated), the food product package 3 ruptured at 80° C. during heating.

### Experimental Example 4

Experimental Example 4 is a case in which a food product 2 (hereinafter referred to as an aerated packaged food product 2) hermetically sealed and packaged in a state in which air at 20° C. was included in a resin container 7 or other food product package 3 having an upper lid 6 was heated to 120° C. at a pressure 0.180 MPa higher than atmospheric pressure.

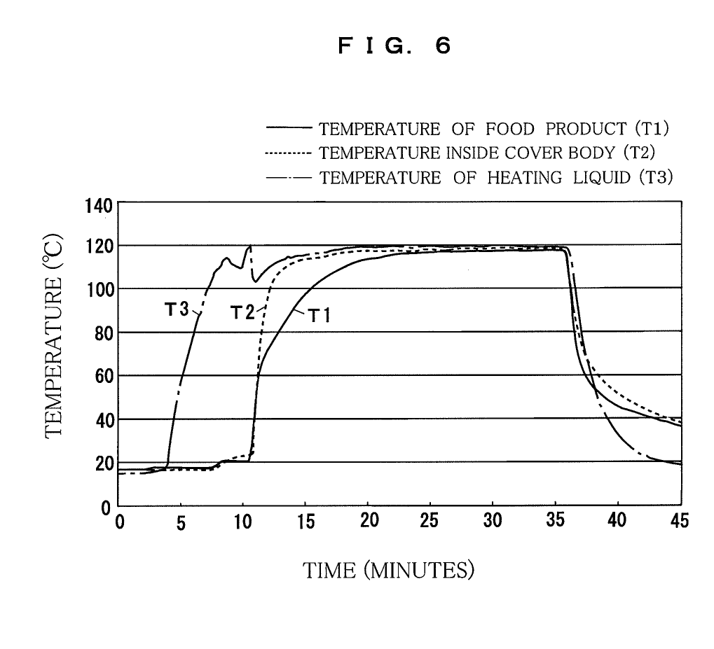

FIG. 6 shows the results in which the temperature of the food product 2 was measured as T1, the temperature inside the case-shaped cover body 4 as T2, and the temperature of the water (heating liquid) of the heating source 8 as T3, in the same manner in Experimental Example 4 as in Experimental Examples 2 and 3.

When water is heated to 120° C., according to Antoine's equation, the saturation vapor pressure of the water is a gauge pressure of 0.097 MPa. The pressure generated by the expansion of air is {(273+120)/(273+20)}×0.101=0.135 MPa (absolute pressure), and the gauge pressure is 0.034 MPa.

In other words, when the food product 2 is heated to 120° C., a gauge pressure of 0.097 (partial pressure of water vapor)+0.034 (partial pressure of air)=0.131 MPa (total pressure) occurring inside can be calculated. However, the actual measured pressure was 0.180 MPa, and an internal pressure approximately 1.4 times the saturation vapor pressure occurred.

Consequently, it was confirmed that a pressure 1.4 times atmospheric pressure was necessary when the food product 2 was heated to 120° C. without rupturing the food product package 3.

When pressure was not applied using air (when the compressor 10 was not operated), the food product package 3 ruptured at 80° C. during heating.

### Experimental Example 5)

Experimental Example 5 is a case in which a food product 2 (hereinafter referred to as an aerated packaged food product 2) hermetically sealed and packaged in a state in which air at 20° C. was included in a resin container 7 or other food product package 3 having an upper lid 6 was heated to 120° C. at a pressure of 0.243 MPa (gauge pressure), which is a pressure 2.5 times the saturation vapor pressure of water at 120° C., and a pressure of 0.291 MPa (gauge pressure), which is a pressure 3 times the saturation vapor pressure of water at 120° C. The aerated packaged food product 2 was inserted into a case-shaped cover body 4 and pressurized by the feeding of air into the hermetically sealed vessel 1 by the compressor 10, and the pressure of 0.243 MPa (gauge pressure), or 2.5 times the saturation vapor pressure at 120° C., was maintained. The water inside the heating source 8 was then heated by a heater to 120° C., and the heated water was dispersed over the case-shaped cover body 4 from the liquid dispersing part 5. The dispersion of hot water was stopped 40 minutes after the start of the experiment, and the water of the cooling source 9 at 20° C. was dispersed from the liquid dispersing part 5 for cooling.

As a result, the food product package 3 did not rupture. When the same experiment was performed with the pressure created by the compressor 10 at 0.291 MPa (gauge pressure), or 3 times the saturation vapor pressure at 120° C., rupturing of the food product package 3 was observed.

Consequently, it was confirmed that even when a pressure 2.5 times atmospheric pressure is applied, the food product package 3 does not rupture, but rupturing does occur when a higher pressure is applied.

In a resin container 7 or other food product package 3 that is sealed by an upper lid 6, the food product package 3 is damaged (ruptured) according to the temperature of the hot water when high-temperature water (heating liquid) is applied at normal pressure (gauge pressure of zero in the hermetically sealed vessel 1). However, the temperature of hot water that damages (ruptures) the food product package 3 is determined from the relationship of the volume of air inside the food product package 3, the seal strength of the food product package 3, and other factors, rupturing (package breakage) was observed at 80° C. in Experimental Examples 1 through 5, and it is known that the problem of rupturing occurs when hot water at 80° C. or higher is applied in cases in which the seal strength or the strength of the food product package 3 itself is low. Accordingly, it can be considered necessary to pressurize the inside of the hermetically sealed vessel 1 when hot water at 80° C. or higher is applied to the food product package 3.

Based on the results of Experimental Examples 1 through 5, heating at a pressure 1.2 or more times atmospheric pressure can be considered necessary when an aerated packaged food product 2 is heated at 80° C.

When water is employed as the heating medium, the medium itself must be pressurized when the water is heated to 100° C. or higher. In heating at 120° C., package breakage can be prevented by maintaining a vapor pressure that is about 1.4 times the saturation vapor pressure.

It was confirmed that the food product package 3 is compressed and ruptured by external pressure when heating is performed while a vapor pressure 2.5 or more times the saturation vapor pressure is maintained.

### Experimental Example 6

Experimental Example 6 is a case in which water 2 (hereinafter referred to as the object being processed) hermetically sealed and packaged in a state in which 10⁸/mL each of E. coli and L. acidophilus were included together with air at 20° C. in a resin container 7 or other food product package 3 having an upper lid 6 was heated to 80° C. at a pressure 0.180 MPa higher than atmospheric pressure. The object being processed was inserted into a case-shaped cover body 4 and pressurized by the feeding of air into the hermetically sealed vessel by the compressor 10, and a pressure of 0.180 MPa was maintained. The water (heating liquid) inside the heating source 8 was then heated by a heater to 80° C., and the heated water was dispersed over the case-shaped cover body 4 from the liquid dispersing part 5. The dispersion of hot water was stopped after 30 minutes, and the water of the cooling source 9 at 20° C. was dispersed from the liquid dispersing part 5 for cooling. The results of detecting E. coli and L. acidophilus in the object being processed were negative.

Based on the results of Experimental Example 6, it was confirmed that the Escherichia coli and L. acidophilus inside were killed without the processed object being ruptured by heating at 80° C.

Since the present example is configured as described above, heat sterilization and heat cooking at 80° C. to 120° C. can be performed for the food product 2 the same as in the past while preventing the packaged food product 2 from rupturing due to the increased internal pressure thereof, and the same heat treatment as that of the conventional technique can be performed for the food product 2 more efficiently than by the conventional technique. Since only the amount of heat needed to heat the liquid injected into the hermetically sealed vessel 1 is needed, the time required to heat the liquid is significantly reduced, and the heat energy required for heating is also significantly reduced relative to the conventional technique in which the entire treatment tank is filled with high-temperature high-pressure hot water, and the food product is immersed in the hot water. Since the food product is not immersed in the water as in the conventional technique, the food product 2 can be recovered by a simple operation after heat treatment, and the moisture removal step is also unnecessary. Efficient production is therefore made possible, and enhanced productivity and reduced cost can be obtained at the same time. Since a heating liquid at a temperature adapted to the purpose can also be injected merely by varying the vapor pressure inside the hermetically sealed vessel 1, the temperature can be easily managed in a structure that uses a heating liquid at a temperature of 100° C. or higher.

In the present invention, since the inside of the hermetically sealed vessel 1 is maintained at a vapor pressure that is higher than the saturation vapor pressure of the heating liquid, the heating liquid is injected into the hermetically sealed vessel 1 while still in the liquid state without vaporization or boiling, and the food product can be heated with good thermal efficiency by the heating liquid. Since the heated food product is also heat treated at the same temperature as the heating liquid without vaporization, boiling, or other state changes occurring therein, heat cooking and heat sterilization can be performed while the food product is maintained in a satisfactory state. In particular, cooking and sterilization can be performed without rupturing the package even in the case of aerated types of packaged food products 2 that include air and other non-condensable gases that could not be treated by the conventional technique.

Even in the case of a hermetically sealed and packaged food product 2 that does not include air or other non-condensable gases as the packaged food product 2, i.e., a de-aerated packaged food product 2, since the liquid is vaporized by heating, and internal pressure that leads to rupturing occurs inside the food product package 3 the present example is also effective in the same manner in such a case.

The present example may also be applied to a food product that is packaged in a metal container, a flexible resin bag (pouch) having heat resistance and airtightness, or the like besides a food product 2 that is hermetically sealed and packaged in a food product package 3.

### Example 2

Example 2 of the present invention will be described.

The present example is a case in which a plurality of non-packaged starch-containing products 2 is arranged and accommodated in the case-shaped cover body 4 shown in FIG. 3, a plurality of the case-shaped cover bodies 4 in which the starch-containing product 2 is accommodated is arranged in the hermetically sealed vessel 1, and a heating liquid at 180° C. is injected into the hermetically sealed vessel 1, whereby the starch-containing product 2 is heated via the case-shaped cover bodies 4. Other aspects of the present example are the same as in Example 1.

A specific experimental example of the present invention is described below.

### Experimental Example 7

In Experimental Example 7, the starch-containing product 2 was inserted into a case-shaped cover body 4 and pressurized by the feeding of air into the hermetically sealed vessel by the compressor 10, and a pressure of 0.901 MPa (the saturation vapor pressure of water in gauge pressure at 180° C.) was maintained. The water inside the heating source 8 was then heated by a heater to 180° C., and hot water at 180° C. was dispersed over the case-shaped cover body 4 via the liquid dispersing part 5. The dispersion of hot water was stopped after 30 minutes, and the water of the cooling source 9 at 20° C. was dispersed from the liquid dispersing part 5 for cooling. The formation of acrylamides was not observed as a result of analyzing the starch.

Since the present example was configured as described above, even when the food product 2 was accommodated without modification in the cover body 4, the food product heat treatment apparatus was capable of preventing the food product 2 from wetting, easily performing cooking and sterilization even when the food product 2 was not packaged, and also suppressing the formation of harmful acrylamides that form during cooking at temperatures of 180° C. or higher during cooking of a starch food product, for example.

1. A food product heat treatment apparatus comprising:
a hermetically sealed vessel in which a prescribed vapor pressure is maintained or can be maintained, and in which a food product or a hermetically sealed and packaged food product is placed;
an injection device part configured to inject a heating liquid into said hermetically sealed vessel; and
a plurality of cover bodies configured to accommodate and cover said food product or hermetically sealed and packaged food product, placed inside said hermetically sealed vessel;
wherein said heating liquid is heated by a heating source;
wherein said injection device part is hermetically sealed and communicates with an inside of said hermetically sealed vessel;
wherein equal vapor pressure is maintained in said injection device part and said hermetically sealed vessel; and
wherein said injection device part comprises a liquid dispersing part configured to inject said heating liquid towards said cover bodies disposed in said hermetically sealed vessel.

2. A food product heat treatment apparatus comprising:
a hermetically sealed vessel into which a food product or a hermetically sealed and packaged food product is placed, and in which a prescribed vapor pressure is maintained;
an injection device part configured to inject a heating liquid into said hermetically sealed vessel;
a plurality of cover bodies configured to accommodate and cover said food product or hermetically sealed and packaged food product, placed inside said hermetically sealed vessel a liquid dispersing part configured to inject said heating liquid towards said cover bodies disposed in said hermetically sealed vessel;
an injection channel part configured to inject said heating liquid into the hermetically sealed vessel, and a recovery channel part configured to recover the heating liquid injected into the hermetically sealed vessel and feed the heating liquid to said injection channel part; and
a recirculation injection device part configured to re-inject said heating liquid recovered from said hermetically sealed vessel via said recovery channel part into said hermetically sealed vessel via said injection channel part, comprising said hermetically sealed vessel, said injection channel part, and said recovery channel part,
wherein said heating liquid is heated by a heat source;
wherein said injection device part is hermetically sealed and communicated with an inside of said hermetically sealed vessel;
wherein equal vapor pressure is maintained in said injection device part and said hermetically sealed vessels; and
wherein said injection device part comprises a liquid dispersing part configured to inject said heating liquid towards said cover bodies disposed in said hermetically sealed vessel.

3. The food product heat treatment apparatus according to claim 2, wherein said recirculation injection device part further comprises said heating source.

4. The food product heat treatment apparatus according to claim 1, wherein said hermetically sealed vessel further comprises a pressurizing device part configured to forcibly pressurize the inside of said hermetically sealed vessel, and maintain said prescribed vapor pressure.

5. The food product heat treatment apparatus according to claim 2, wherein said hermetically sealed vessel further comprises a pressurizing device part configured to forcibly pressurize the inside of said hermetically sealed vessel, and maintain said prescribed vapor pressure.

6. The food product heat treatment apparatus according to claim 3, wherein said hermetically sealed vessel further comprises a pressurizing device part configured to forcibly pressurize the inside of said hermetically sealed vessel, and maintain said prescribed vapor pressure.

7. The food product heat treatment apparatus according to claim 1, wherein said liquid dispersing part is configured to inject said heating liquid into said hermetically sealed vessel in a dispersed fashion.

8. The food product heat treatment apparatus according to claim 2, wherein said liquid dispersing part is configured to inject said heating liquid into said hermetically sealed vessel in a dispersed fashion.

9. The food product heat treatment apparatus according to claim 3, wherein said liquid dispersing part injects said heating liquid into said hermetically sealed vessel in a dispersed fashion.

10. The food product heat treatment apparatus according to claim 4, wherein said liquid dispersing part injects said heating liquid into said hermetically sealed vessel in a dispersed fashion.

11. The food product heat treatment apparatus according to claim 5, wherein said liquid dispersing part injects said heating liquid into said hermetically sealed vessel in a dispersed fashion.

12. The food product heat treatment apparatus according to claim 6, wherein said liquid dispersing part injects said heating liquid into said hermetically sealed vessel in a dispersed fashion.
